(19) United States
(12) Patent Application Publication
(10) Pub. No.: US 2026/0269516 A1
(43) Pub. Date: Sep. 10, 2026

(54) CABLE CONNECTOR

(71) Applicant: ACES ELECTRONICS CO., LTD., Taoyuan (TW)

(72) Inventors: Kuo-Hua HUANG, Taoyuan (TW); Chu-Cheng WU, Taoyuan (TW)

(21) Appl. No.: 19/316,125

(22) Filed: Sep. 2, 2025

(30) Foreign Application Priority Data
Mar. 6, 2025 (TW) 114202278

(51) Int. Cl. H01R 13/52; H01R 13/504; H01R 13/506; H01R 13/66; H01R 24/28; H01R 24/60; H01R 107/00

(52) U.S. Cl. CPC H01R 13/5208; H01R 13/504; H01R 13/506; H01R 13/5216; H01R 13/6658; H01R 24/28; H01R 24/60; H01R 2107/00

(57) ABSTRACT

A cable connector includes an insulating housing, an electrical module installed in the insulating housing including a tongue plate and a plurality of connecting portions and welding portions, a plurality of cables welded by the welding portions of the electrical module, and a gasket installed outside the electrical module to cover and fix the tongue plate and the plurality of cables and fill the gaps between the adjacent plurality of cables to prevent the glue generated during an insert molding process outside the electrical module from flowing into the welding portions of the tongue plate and the welding points of the plurality of cables. This can achieve the purpose of reducing the insertion loss and the return loss during the high-frequency operation.

This application claims the priority benefit of Taiwan patent application number 114202278, filed on Mar. 6, 2025.

### BACKGROUND OF THE INVENTION

### 1. Field of the Invention

The present invention relates to a cable connector, particularly when an electrical module is installed in an insulating housing, a glue needs to be filled at the rear end where a tongue plate and a plurality of cables are connected by an insert molding process, and the filled glue can fix the tongue plate and the plurality of cables to form a stable structure and a waterproof structure. By covering and fixing the tongue plate and the plurality of cables with a gasket, the glue can be prevented from flowing into the welding portions of the tongue plate and the welding points of the plurality of cables during the insert molding process, so that the welding portions of the tongue plate and the welding points of the plurality of cables remain in contact with the air, thereby achieving the purpose of reducing the insertion loss and the return loss during the high-frequency operation.

### 2. Description of the Related Art

According to the current rapid growth and maturity of the electronics industry, many different 3C functional electronic products are developed and manufactured according to different needs. In particular, the alternate, change speed of computers, laptops, tablets and smartphones is beyond imagination. The direction of the update is nothing more than processor computing speed, network transmission speed and lighter, thinner, shorter and smaller size. In addition to being smaller in size, electronic products also need to be equipped with different interface connectors to accommodate the expansion of more functions.

Furthermore, the miniaturization of electronic products is largely due to the advancement of wafer manufacturing processes. When the circuit board and the corresponding connector are miniaturized, the distance between the terminals of the terminal sets is too close, and electromagnetic waves and cross-talk interference are generated when transmitting high-frequency signals. The cross-talk interference problem has an absolute impact on the transmission signal speed. The high-frequency cable connector includes an insulating body, differential signal cores installed in the insulating body, and grounding cores adjacent to the differential signal cores. The trace spacing between the differential signal cores must be consistent throughout the entire routing track. Otherwise, the spacing change will cause unbalanced magnetic field coupling, thereby reducing the effect of magnetic field elimination and causing the increase in electromagnetic interference (EMI). The biggest impact of the increase in electromagnetic interference is that it increases the attenuation value of the transmission signal of the differential signal cores, thereby reducing the speed of the transmission signal of the differential signal cores. Furthermore, if the welding points between the differential signal cores and the circuit board covered with plastic, the resulting insertion loss and return loss may also increase the attenuation value of the transmission signal. The above-mentioned problems have caused the poor overall impedance matching of the electrical connector, and it is yet to be solved by the industry.

### SUMMARY OF THE INVENTION

Therefore, in view of the above problems and deficiencies, the inventor collected relevant information and, after multiple evaluations and considerations, designed the invention of this cable connector.

The main object of the present invention is to provide a cable connector, which comprises an insulating housing having an accommodation chamber formed therein; an electrical module installed in the accommodation chamber, and comprising a tongue plate having a plurality of connecting portions and a plurality of welding portions respectively disposed on two sides of at least one surface thereof, and a plurality of cables welded to the welding portions; and a gasket installed outside the electrical module to cover and fix the tongue plate and the plurality of cables and fill the gaps between the adjacent plurality of cables, and to prevent the glue generated during the insert molding process outside the electrical module from flowing into the welding portions of the tongue plate and the welding points of the plurality of cables. As mentioned above, after the electrical module is installed in the insulating housing, the rear end where the tongue plate and the plurality of cables are connected needs to be filled with a glue through the insert molding process. The filled glue can fix the tongue plate and the plurality of cables to form a stable structure and a waterproof structure. By covering the and fixing the tongue plate and the plurality of cables with the gasket, the glue can be prevented from flowing into the welding portions of the tongue plate and the welding points of the plurality of cables during the insert molding process, so that the welding portions of the tongue plate and the welding points of the plurality of cables can remain in contact with the air. This can achieve the purpose of reducing the insertion loss and the return loss during the high-frequency operation.

Another object of the present invention is that the gasket is made of an elastic rubber or silicone material in the form of an integrated hollow frame. The gasket has a receiving cavity inside for covering and fixing the tongue plate and the plurality of cables, and a plurality of ribs are disposed in the receiving cavity for filling the gaps between the adjacent plurality of cables.

Still another object of the present invention is that the gasket further comprises a fixing portion formed at the outer edge thereof near the tongue plate for engaging with the accommodation chamber, and two blocking mechanisms provided on two opposite sides thereof away from the tongue plate for blocking the glue; each blocking mechanism comprises an upper convex plate and a lower convex plate which are opposite to each other and abut against the outside of the plurality of cables, a positioning space formed between the upper convex plate and the lower convex plate for respective positioning portions on both sides of the tongue plate away from the connecting portions to be locked and positioned; the gasket further comprises two latching portions respectively formed on both sides of the receiving cavity. The two latching portions are used to engage and fix respective recessed latching grooves on both sides of the tongue plate adjacent to the positioning portions.

### BRIEF DESCRIPTION OF THE DRAWINGS

FIG. 1 is a three-dimensional external view of the cable connector of the present invention.

FIG. 2 is a three-dimensional external view of the cable connector of the present invention from another viewing angle.

FIG. 3 is a three-dimensional exploded view of the cable connector of the present invention.

FIG. 4 is a three-dimensional exploded view of the cable connector of the present invention from another viewing angle.

FIG. 5 is a side cross-sectional view of the cable connector of the present invention.

FIG. 6 is a three-dimensional external view of a second embodiment of the cable connector of the present invention.

FIG. 7 is a partial three-dimensional exploded view of the second embodiment of the cable connector of the present invention.

FIG. 8 is a partial three-dimensional exploded view of the second embodiment of the cable connector of the present invention from another viewing angle.

FIG. 9 is a three-dimensional exploded view of the second embodiment of the cable connector of the present invention.

FIG. 10 is a three-dimensional exploded view of the second embodiment of the cable connector of the present invention from another viewing angle.

FIG. 11 is a side cross-sectional view of the second embodiment of the cable connector of the present invention.

### DETAILED DESCRIPTION OF THE PREFERRED EMBODIMENT

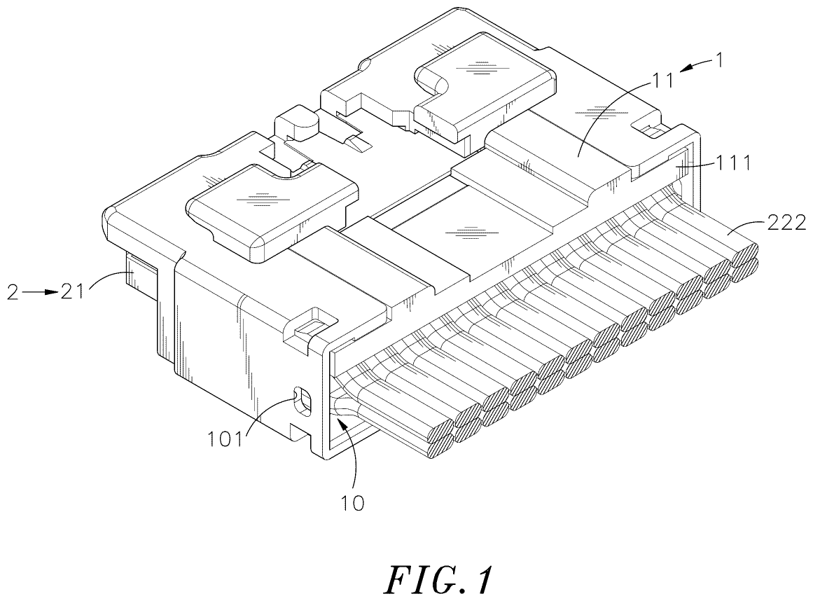

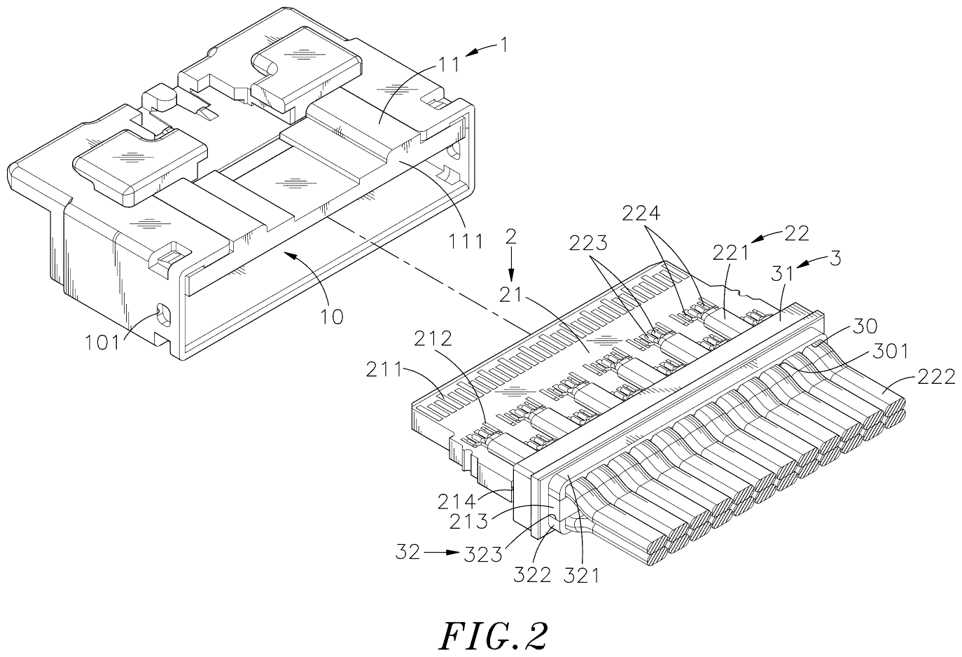

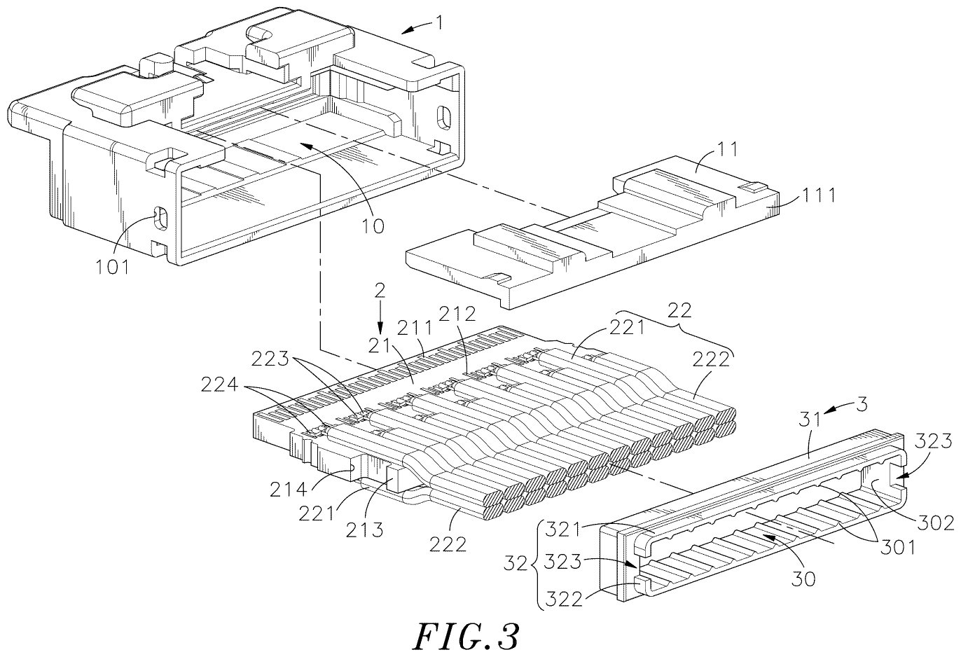

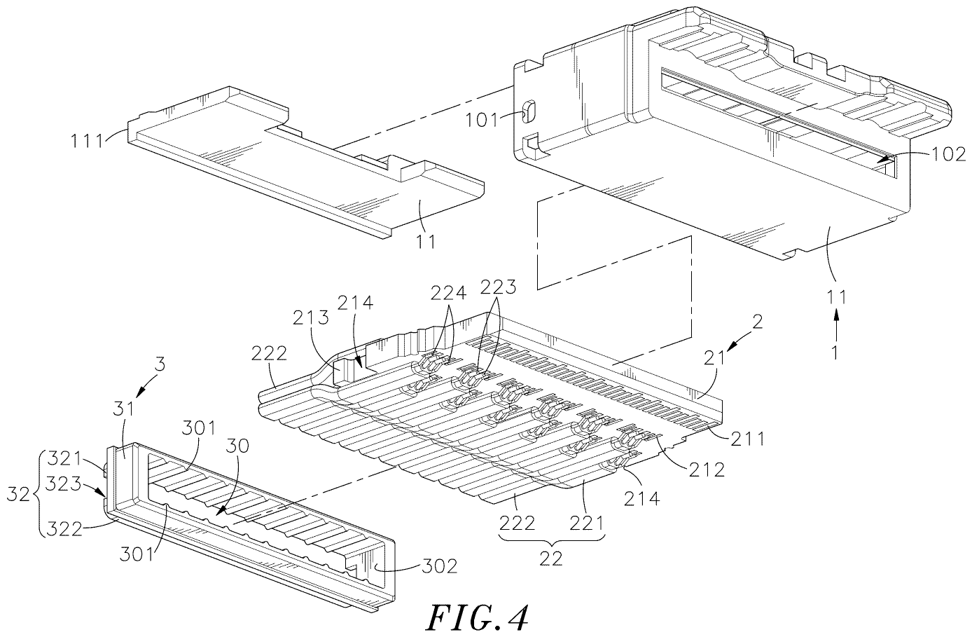

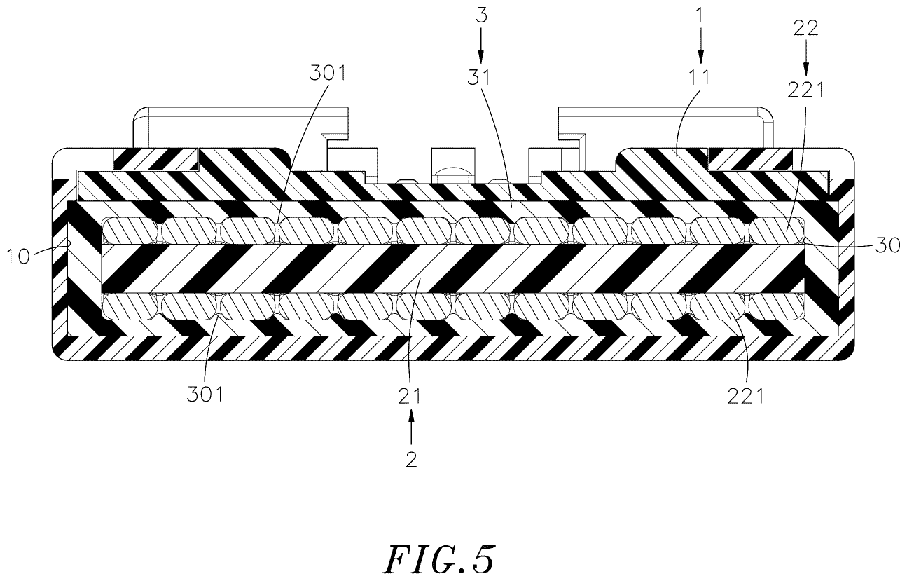

Please refer to FIGS. 1 to 5, which are respectively a three-dimensional external view, a three-dimensional external view from another viewing angle, a three-dimensional exploded view, a three-dimensional exploded view from another viewing angle and a side cross-sectional view of the cable connector of the present invention. The first embodiment of the cable connector of the present invention mainly comprises an insulating housing 1, an electrical module 2 and a gasket 3, and the detailed structure and connection relationship are as follows:

The insulating housing 1 has an accommodation chamber 10 formed therein.

The electrical module 2 is installed in the accommodation chamber 10. The electrical module 2 comprises a tongue plate 21, and a plurality of connecting portions 211 and a plurality of welding portions 212 respectively disposed on two sides of at least one surface of the tongue plate 21. The welding portions 212 are used for welding the cores of a plurality of cables 22.

The gasket 3 is installed outside the electrical module 2. The gasket 3 covers and fixes the tongue plate 21 and the plurality of cables 22 and fills the gaps between the adjacent plurality of cables 22, and can prevent the glue generated during the insert molding process outside the electrical module 2 from flowing into the welding portions 212 of the tongue plate 21 and the welding points of the plurality of cables 22.

The above-mentioned insulating housing 1 further comprises an injection hole 101 located on two opposite sides thereof and communicating with the accommodation chamber 10 for injecting the glue (not shown) injected into the mold, a docking opening 102 located on the front end of the accommodation chamber 10 for allowing one side of the tongue plate 21 that is provided with the connecting portions 211 to extend outward, and a cover plate 11 engaged and positioned in the hollow top thereof. The cover plate 11 is bent downward at a side away from the tongue plate 21 to form a supporting portion 111 that contacts the upper edge of the gasket 3.

The above-mentioned tongue plate 21 is formed of a printed circuit board (PCB), and the connecting portions 211 and the welding portions 212 are formed of a copper foil layer disposed in the PCB. Alternatively, the tongue plate 21 is formed of an insulating base (not shown), and the connecting portions 211 and the welding portions 212 are formed of a plurality of conductive terminals (not shown) penetrating the insulating base. The present invention does not impose any limitation on the structure of the tongue plate 21.

The above-mentioned plurality of cables 22 include a plurality of front cables 221 with a longer length and a plurality of rear cables 222 with a shorter length, and the front cables 221 and the rear cables 222 are arranged in a staggered manner. The front cables 221 and the rear cables 222 both include four cores, which classified into two signal cores 223 located in the center and two ground cores 224 located at two outer sides. The preferred embodiment of the signal cores 223 are differential signal cores. Furthermore, the ground cores 224 are welded to the welding portions 212 of the tongue plate 21, and can guide the electromagnetic waves generated by the signal cores 223 during the high-speed transmission of electronic signals to the inner layer (not shown) of the tongue plate 21 or the grounding area of other components for elimination, thereby significantly reducing the electromagnetic interference (EMI) effect.

The above-mentioned gasket 3 is made of elastic rubber or silicone material and is composed of an integrated hollow frame. The gasket 3 comprises a receiving cavity 30 for covering and fixing the tongue plate 21 and the plurality of cables 22 therein, a plurality of ribs 301 disposed in the receiving cavity 30 for filling gaps between the adjacent plurality of cables 22, a fixing portion 31 formed at the outer edge thereof near the tongue plate 21 for engaging with the accommodation chamber 10, and two blocking mechanisms 32 provided on two opposite sides thereof away from the tongue plate 21 for blocking the glue. Each blocking mechanism 32 comprises an upper convex plate 321 and a lower convex plate 322 which are opposite to each other and abut against the outside of the plurality of cables 22, a positioning space 323 formed between the upper convex plate 321 and the lower convex plate 322 for respective positioning portions 213 on both sides of the tongue plate 21 away from the connecting portions 211 to be locked and positioned. The gasket 3 further comprises two latching portions 302 respectively formed on both sides of the receiving cavity 30. The two latching portions 302 are used to engage and fix respective recessed latching grooves 214 on both sides of the tongue plate 21 adjacent to the positioning portions 213.

When the cable connector shown in FIGS. 1 to 5 is actually assembled, the signal cores 223 and the ground cores 224 of the plurality of cables 22 are first welded to the plurality of welding portions 212 on the two surfaces of the tongue plate 21 which are staggered in front and back, and the plurality of cables 22 extending backward on the two surfaces of the tongue plate 21 are bent toward the middle to fit together. Then, the gasket 3 is placed outside the tongue plate 21 and the plurality of cables 22 near the bend, and the two latching portions 302 in the gasket 3 are engaged with the latching grooves 214 of the tongue plate 21, and the positioning portions 213 of the tongue plate 21 are engaged with the positioning spaces 323 of the gasket 3. After the supporting portion 111 of the cover plate 11 downwardly contact with the upper edge of the gasket 3, the combined structure of the tongue plate 21, the plurality of cables 22 and the cover plate 11 can be pushed into the accommodation chamber 10 of the insulating housing 1 by means of a pushing fixture, and the connecting portions 211 of the tongue plate 21 are extended and exposed outside the docking opening 102 of the insulating housing 1. At the same time, the cover plate 11 is fixed by the clamps (not marked) on the two sides of the upper part thereof and the corresponding hollow button holes (not marked) of the insulating housing 1 (The assembly of the cover plate 11 and the insulating housing 1 may also be fixed by ultrasonic welding, so there is no restriction on the fixing method.). The injection holes 101 on both sides of the insulating housing 1 can be used for injection and filling of the glue injected into the mold. After the filled glue is cured, it can fix the tongue plate 21 and the plurality of cables 22 to form a stable structure and a waterproof structure. The fixed plurality of cables 22 have the effect of improving the near-end crosstalk (NEXT) and far-end crosstalk (FEXT) problems. By covering and fixing the tongue plate 21 and the plurality of cables 22 with the gasket 3, it is possible to prevent the glue from flowing into the welding portions 212 of the tongue plate 21 and the welding points of the plurality of cables 22 through the capillary phenomenon during the insert molding process, so that the welding portions 212 of the tongue plate 21 and the welding points of the plurality of cables 22 are kept in contact with the air, thereby controlling the impedance matching of the cable connector and reducing the attenuation of the transmission signal caused by the insertion loss and the return loss.

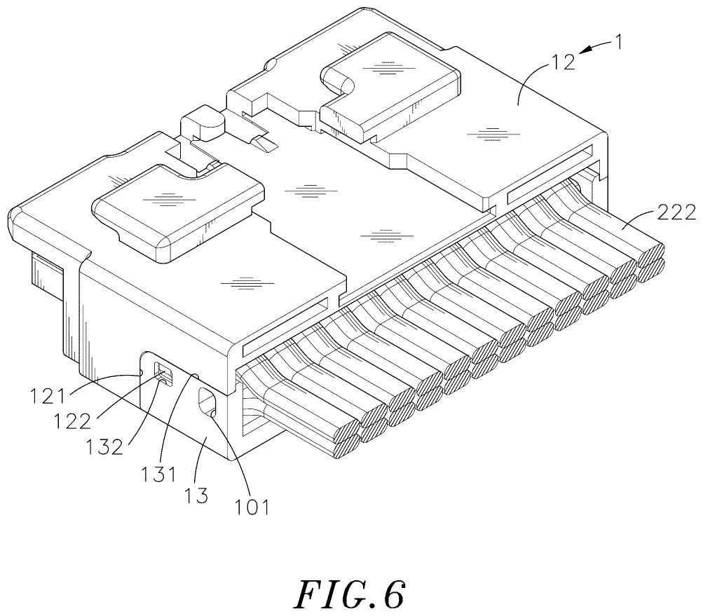

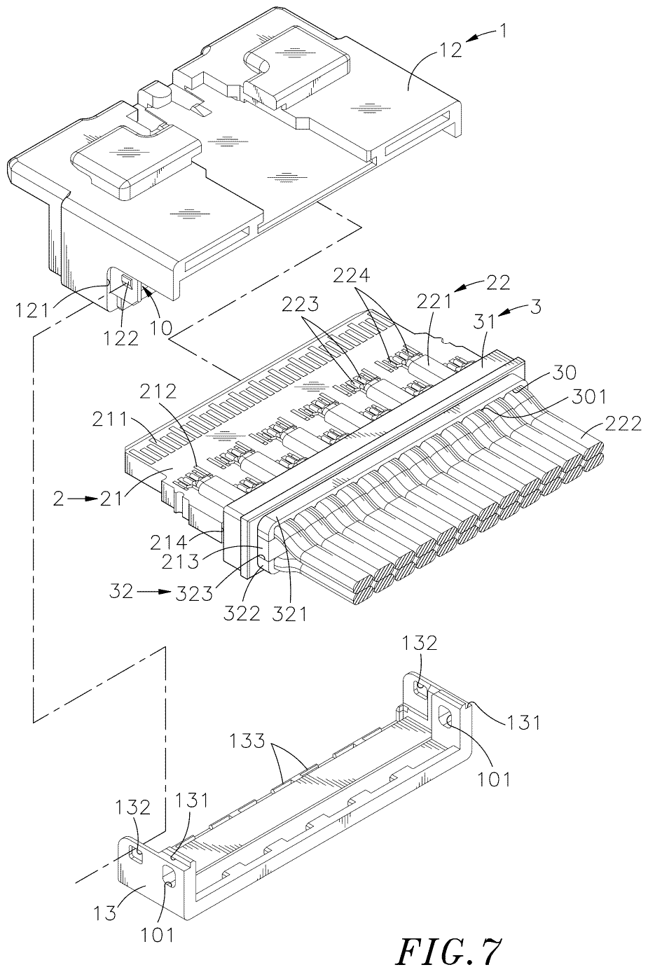

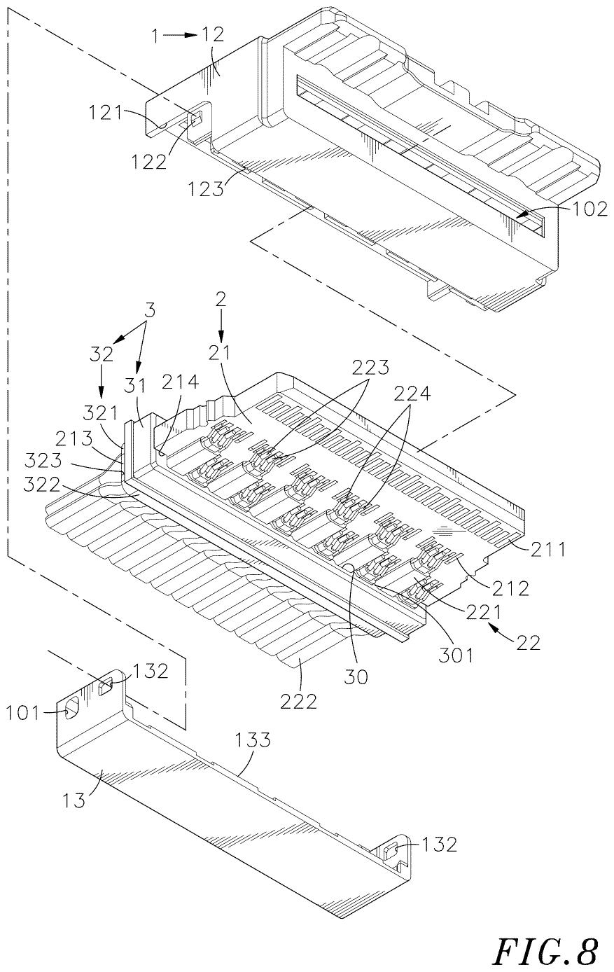

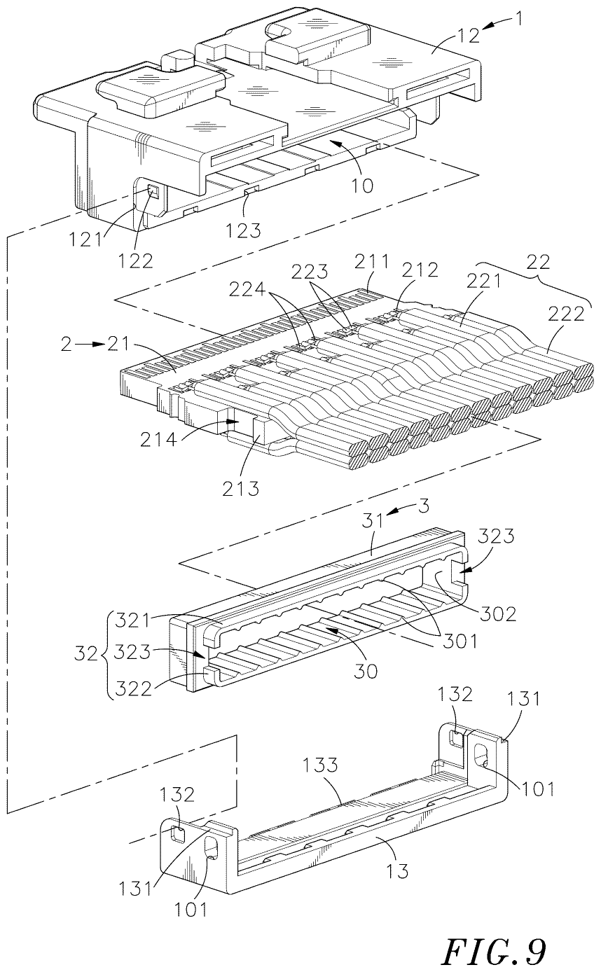

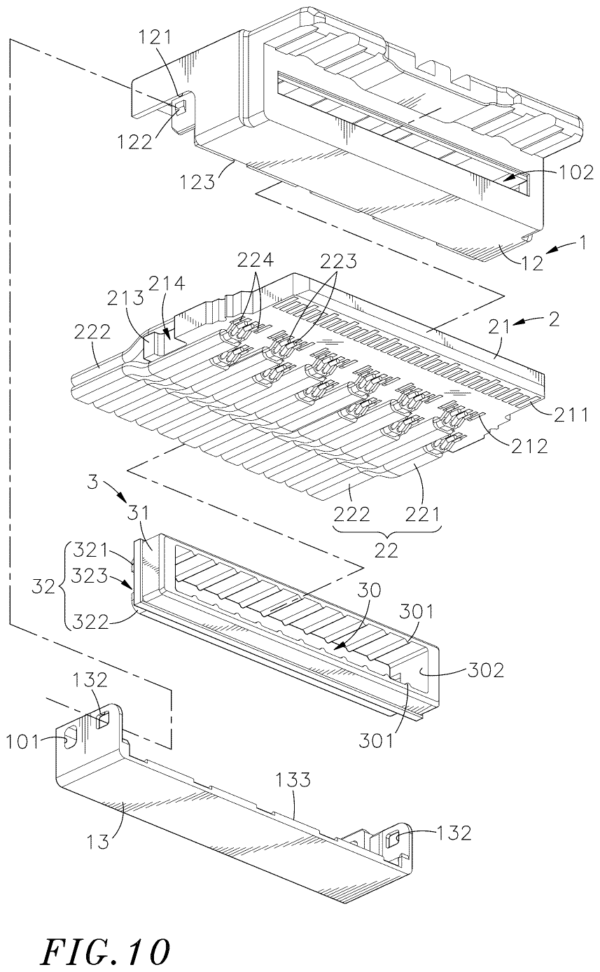

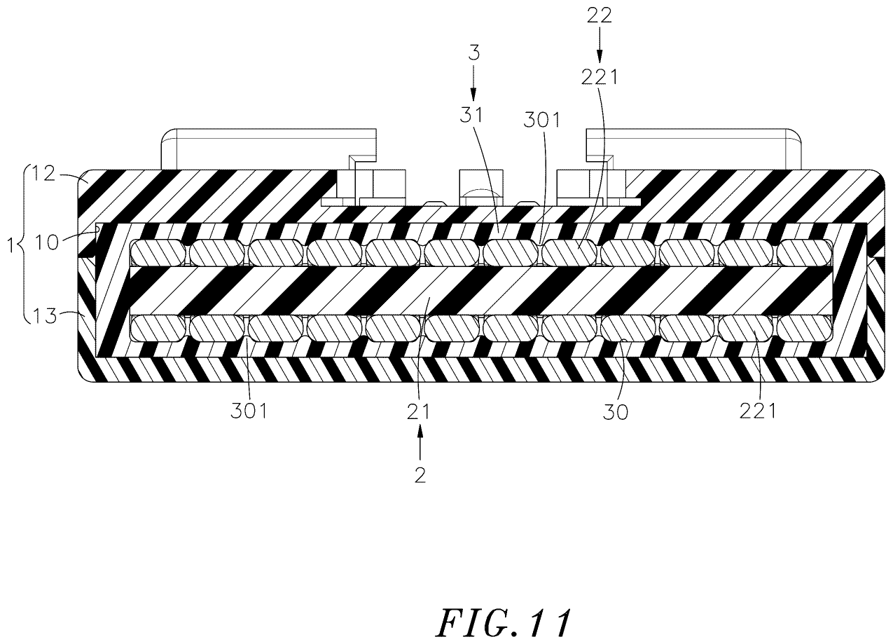

Please refer to FIGS. 6 to 11, which are respectively a three-dimensional external view, a partial three-dimensional exploded view, a partial three-dimensional exploded view from another viewing angle, a three-dimensional exploded view, a three-dimensional exploded view from another viewing angle and a side cross-sectional view of the second embodiment of the cable connector of the present invention. The difference between the second embodiment of the cable connector and the first embodiment disclosed in FIGS. 1 to 5 is only the structure of the insulating housing 1. As for the electrical module 2 and the gasket 3, they are the same and therefore will not be described again. The structure of the insulating housing 1 of the second embodiment is as follows:

The insulating housing 1 comprises a first shell 12 having the accommodation chamber 10 therein, and a second shell 13 coupled to the first shell 12, wherein the joint between the first shell 12 and the second shell 13 is formed into an integrated structure by ultrasonic welding. The rear ends of the two side plates of the first shell 12 are recessed toward the electrical module 2 to form a respective first welding portion 121, and the two side plates of the second shell 13 are formed with a respective second welding portion 131 corresponding to the respective first welding portion 121. The joint between the first welding portions 121 and the second welding portions 131 is provided with a positioning structure including buckles 122, buckle grooves 132, clip strips 133 and positioning grooves 123.

When the cable connector disclosed in FIGS. 6 to 11 is actually assembled, the gasket 3 is first placed outside the tongue plate 21 of the electrical module 2 and the plurality of cables 22 close to the bend, and the two latching portions 302 in the gasket 3 are engaged with the latching grooves 214 of the tongue plate 21, and the positioning portions 213 of the tongue plate 21 are engaged with the positioning spaces 323 of the gasket 3. Then, the electrical module 2 is positioned in the accommodation chamber 10 of the first shell 12 by means of push-fit engagement, and the front end of the tongue plate 21 with the plurality of connecting portions 211 is exposed from the first shell 12. The first welding portions 121 of the first shell 12 are aligned with the second welding portions 131 of the second shell 13, and the buckles 122 and the positioning grooves 123 of the first welding portions 121 are engaged and positioned with the buckle grooves 132 and the clip strips 133 of the second welding portions 131. Then, by applying pressure to the second shell 13 by holding the top surface of the first shell 12 downward with the pressurizing fixture, supersonic vibration waves can be applied to the joint between the first welding portions 121 of the first shell 12 and the second welding portions 131 of the second shell 13. Ultrasonic frequency friction is generated at the joint of the first welding portions 121 and the second welding portions 131 to generate high temperature, so that the joint of the first shell 12 and the second shell 13 is welded to form an integrated structure to complete the assembly, and the first shell 12 and the second shell 13 can be firmly pressed against the gasket 3 and the surfaces of the plurality of cables 22, and the cores of the plurality of cables 22 can be more firmly in contact with the welding portions 212 of the tongue plate 21. At the same time, the top and bottom sides of the gasket 3 formed of rubber or silicone material are also melted with the first shell 12 and the second shell 13 through supersonic vibration waves to form an integrated stable structure, which can prevent the gasket 3 from being moved back due to the stress when the cable connector and the matching connector (such as board-end connector) are plugged in, thereby preventing various problems such as PIN retreat or separation of the cores and the welding portions 212 so as to cause poor contact or electrical disconnection. At the same time, the ultrasonic welding method is used for the first shell 12 and the second shell 13 so that the gasket 3 will not be twisted and deformed inside the first shell 12 during the assembly process, thereby preventing the glue from flowing into the welding portions 212 of the tongue plate 21 and the welding points 212 of the plurality of cables 22 through the capillary phenomenon during the insert molding process.

The main feature of the present invention is that after the electrical module 2 is installed in the insulating housing 1, the tongue plate 21 and the plurality of cables 22 are connected to each other at the rear end and filled with glue through the insert molding process. The filled glue can fix the tongue plate 21 and the plurality of cables 22 to form a stable structure and a waterproof structure. By covering and fixing the tongue plate 21 and the plurality of cables 22 with the gasket 3, the glue can be prevented from flowing into the welding portions 212 of the tongue plate 21 and the welding points of the plurality of cables 22 during the insert molding process of the glue, so that the welding portions 212 of the tongue plate 21 and the welding points of the plurality of cables 22 are kept in contact with the air, thereby achieving the purpose of reducing the insertion loss and the return loss during the high-frequency operation.

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

In summary, the cable connector of the present invention can achieve its effect and purpose when used, so the present invention is truly a creation with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate.

What the invention claimed is:

1. A cable connector, comprising:
an insulating housing having an accommodation chamber formed therein.
an electrical module installed in said accommodation chamber, said electrical module comprising a tongue plate and a plurality of connecting portions and a plurality of welding portions respectively disposed on two opposing sides of at least one surface of said tongue plate, said welding portions being welded respective cores of a plurality of cables; and
a gasket installed outside said electrical module, said gasket covering and fixing said tongue plate and said plurality of cables and filling the gaps between the adjacent said plurality of cables to prevent a glue generated during an insert molding process outside said electrical module from flowing into said welding portions of said tongue plate and the welding points of said plurality of cables.

2. The cable connector as claimed in claim 1, wherein said gasket is selectively made of a flexible rubber or silicone material and is composed of an integrated hollow frame.

3. The cable connector as claimed in claim 1, wherein said gasket comprises a receiving cavity for covering and fixing said tongue plate and said plurality of cables therein, and a plurality of ribs disposed in said receiving cavity for filling gaps between the adjacent said plurality of cables.

4. The cable connector as claimed in claim 1, wherein said gasket further comprises a fixing portion formed at an outer edge thereof near said tongue plate for engaging with said accommodation chamber, and two blocking mechanisms provided on two opposite sides thereof away from said tongue plate for blocking said glue, each said blocking mechanism comprising an upper convex plate and a lower convex plate which are opposite to each other and abut against the outside of said plurality of cables, a positioning space formed between said upper convex plate and said lower convex plate; said tongue plate further comprises two positioning portions located on two opposite sides thereof away from said connecting portions to be locked and positioned with said positioning spaces of said gasket

5. The cable connector as claimed in claim 4, wherein said gasket further comprises two latching portions respectively formed on two opposite sides of said receiving cavity; said tongue plate further comprises two recessed latching grooves located on the two opposite sides thereof adjacent to said positioning portions and engaged and fixed with said two latching portions of said gasket.

6. The cable connector as claimed in claim 1, wherein said insulating housing further comprises an injection hole located on two opposite sides thereof and communicating with said accommodation chamber for injecting a glue injected into a mold, a docking opening located on a front end of said accommodation chamber for allowing one side of said tongue plate that is provided with said connecting portions to extend outward and a cover plate engaged and positioned in a hollow top thereof, said cover plate being bent downward at a side away from said tongue plate to form a supporting portion that contacts an upper edge of said gasket.

7. The cable connector as claimed in claim 1, wherein said insulating housing comprises a first shell having said accommodation chamber therein and a second shell coupled to said first shell, wherein a joint between said first shell and said second shell being formed into an integrated structure by ultrasonic welding.

8. The cable connector as claimed in claim 7, wherein said first shell comprises two side plates, two first welding portions respectively recessed respective rear ends of said two side plates of said first shell toward said electrical module; said second shell comprises two side plates, two second welding portions formed on the two side plates of said second shell corresponding to said first welding portions of said first shell; said insulating housing further comprises a positioning structure located at the joint between said first welding portions and said second welding portions, the positioning structure comprising buckles, buckle grooves, clip strips and positioning grooves.

9. The cable connector as claimed in claim 1, wherein said tongue plate is selectively formed of a printed circuit board, and said connecting portions and said welding portions of said tongue plate are formed of a copper foil layer disposed in the printed circuit board, or alternatively said tongue plate is formed of an insulating base, and said connecting portions and said welding portions of said tongue plate are formed of a plurality of conductive terminals penetrating the insulating base.

10. The cable connector as claimed in claim 1, wherein said plurality of cables classified into a plurality of front cables with a longer length and a plurality of rear cables with a shorter length, said front cables and said rear cables being arranged in a staggered manner, said front cables and said rear cables each comprising four cores, namely two signal cores located at a central position and two ground cores located at two outer sides.
